(19) United States
(12) Patent Application Publication
(10) Pub. No.: US 2014/0086970 A1
(43) Pub. Date: Mar. 27, 2014

(54) SILVER CHLORIDE COMPOSITIONS FOR DEODORIZATION AND DISINFECTION

(71) Applicant: Thomas D. White, Swansea (GB)

(72) Inventor: Thomas D. White, Swansea (GB)

(73) Assignee: SILVER ANTI-BAC, LLC, Leesburg, IN (US)

(21) Appl. No.: 14/007,110

(22) PCT Filed: Mar. 23, 2012
(86) PCT No.: PCT/US2012/030258

§ 371 Date: Dec. 4, 2013

Related U.S. Application Data
(60) Provisional application No. 61/466,990, filed on Mar. 24, 2011.

(51) Int. Cl. A01N 25/26; A01N 59/16; A01N 33/12

(52) U.S. Cl. CPC A01N 25/26; A01N 33/12; A01N 59/16
USPC 424/421; 424/618

(57) ABSTRACT

An antimicrobial system including inert carrier particles coated with a silver salt in combination with a primary disinfectant is disclosed. Some aspects relate to a disposable wipe for use in cleaning and disinfecting, the disposable wipe including a antimicrobial system. Other aspects relate to a sprayable disinfectant including a liquid carrier. Inert carrier particles, coated with a silver salt, are dispersed in the liquid carrier with a primary disinfectant. Optional additives including surfactants, dispersants, and stabilizers, may also be added.

### CROSS REFERENCE TO RELATED APPLICATIONS

This application is being filed on 23 Mar. 2012 as a PCT International Patent Application and claims priority to U.S. Provisional Application Ser. No. 61/466,990 filed on 24 Mar. 2011, titled SILVER CHLORIDE COMPOSITIONS FOR DEODORIZATION AND DISINFECTION, which is incorporated by reference herein in its entirety.

### BACKGROUND

Disinfectants and antimicrobial agents have been used in a wide range of processes and products to eliminate bacteria and viruses. Disinfectants may be applied to an article, to destroy various pathogens and sterilize the surface of the article. Traditional disinfectants have included alcohols including isopropyl alcohol, amines including ethanolamines, quaternary amines including dialkyl dimethyl ammonium chloride, and bleach. Such traditional disinfectants are often diluted into a liquid carrier that is then applied to the article to be disinfected.

While effective at immediately killing micro-organisms, traditional disinfectants lack long acting capabilities. Such traditional disinfectants are often liquid themselves and may evaporate with the liquid carrier shortly after application. These traditional disinfectants may also we wiped, or rinsed away. Accordingly, the disinfected articles may quickly become re-contaminated with exposure to micro-organisms.

Accordingly, there is a need for long acting disinfectants that can be effective as an antimicrobial agent on a surface. Further, there is a need for a disinfectant that will remain effective against micro-organisms after evaporation of a liquid carrier. There is yet a further need for a disinfectant that is not susceptible to being wiped from a surface.

### SUMMARY

Some embodiments relate to an antimicrobial system including inert carrier particles coated with silver chloride. The particles are dispersed into or onto a matrix. A primary disinfectant is also included.

Other embodiments relate to A disposable wipe for use in cleaning and disinfecting, the disposable wipe including a fibrous substrate. A liquid carrier is impregnated throughout the fibrous substrate and includes inert carrier particles distributed over the substrate. The inert carrier particles are coated with silver a silver salt. The formulation includes a primary disinfectant.

Yet other embodiments relate to a sprayable disinfectant including a liquid carrier. Inert carrier particles, coated with a silver salt, are dispersed in the liquid carrier with a primary disinfectant. Optional additives including surfactants, dispersants, and stabilizers, may also be added.

### DETAILED DESCRIPTION

In some embodiments, an antimicrobial system may be provided having inert carrier particles coated with an insoluble silver salt. An exemplary silver salt for such applications in silver chloride. The coated carrier particles may be dispersed into or onto a matrix. As used in this description and the appended claims, the terms “into” and “onto” in reference to application of a substance to a matrix should be considered interchangeable and co-extensive in definition. Exemplary carrier particles are those of titanium dioxide.

The matrix may be a liquid, such as an aqueous solution, in which the coated particles are dispersed. In some such embodiments, additional ingredients may be added to the liquid matrix. These ingredients may include a variety of compounds designed to improve efficacy and/or stability of the antimicrobial system. Such ingredients may include surfactants such as alcohols and other compounds selected to alter the surface tension or other physical characteristics of the antimicrobial system. Dispersants may also be utilized to more evenly distribute the silver chloride coated inert carrier particles and/or prevent agglomeration. Various stabilizers may also be useful in the liquid matrix antimicrobial system. It should be noted that may chemical species exhibit the properties of one or more of a surfactant, a stabilizer, and/or a dispersant. Suitable surfactants may include alcohols, polyols, and/or mixtures thereof. Nothing in this description or the appended claims describing a particular chemical species as one or another of these functional types should exclude the same chemical species from being considered to simultaneously be another of these functional types. Accordingly, a single chemical species added to the liquid matrix may simultaneously occupy any or all of the functional types, provided that the chemical species in question performs the functionality described or understood to be carried out by those functional types. The particular combinations of chemical species used in the liquid antimicrobial systems may be selected for the particular use. For example, if the system is to be sprayed onto a surface from a pump sprayer, the surface tension of the system should be adjusted to be amenable to delivery through a spray nozzle. Similarly, if the system aerosolized, or impregnated onto a wipe, different physical properties may be more advantageous. Various other additives may be used. For example, xanthan gum may be used to adjust viscosity of the system. Exemplary xanthan gums may include FMC XG 80 and FMC XG 65, both available from FMC BIOPOLYMER.

In some embodiments a liquid antimicrobial system may be applied to a fibrous substrate to provide a damp wipe that a user may use to disinfect a surface. The liquid antimicrobial system may be applied to the wipe in a variety of ways known in the art and be stored in packaging to minimize or avoid drying of the wipe until they are removed from the package. When used the silver chloride coated inert carrier particles may be deposited onto the surface with a portion of the rest of the liquid antimicrobial system. The liquid matrix may then evaporate or otherwise be removed from the surface leaving the silver chloride coated inert carrier particles behind to provide a long acting antimicrobial agent on the surface.

Some embodiments of the liquid antimicrobial system may include other functional agents. These agents may include traditional cleaning agents, the presence of which allows for the system to be used simultaneously as a cleaner and long term antimicrobial treatment. Further, a traditional antimicrobial agent, such as an alcohol, ammonium compound (including ethanolamine, quaternary ammonium compounds, or other biocidal ammonium compounds), bleach, or other traditional antimicrobial agent may be included. The addition of such agents can be used to provide greater immediate biocidal activity for the system such that the surface may be quickly disinfected. While the biocidal activity of these traditional antimicrobial agents is short lived, the silver chloride coated inert carrier particles left on the surface provide a long lived biocidal activity.

In some embodiments, the matrix may be a solid matrix. Mixed into the matrix are the silver chloride coated inert carrier particles. The matrix may include bulking agents. The matrix may also include additives such as surfactants, dispersants, and/or stabilizers to minimize or prevent agglomeration and/or increase even distribution of the silver chloride coated inert carrier particles.

An exemplary solid matrix may be a free flowing particle matrix. Other embodiments may include a pelletized form where the solid matrix within the pellets is relatively fixed and the other ingredients, including the silver chloride coated inert carrier particles, are dispersed within the pellet. The solid matrix antimicrobial system may be mixed with water to provide a disinfecting product. Alternatively, the solid matrix antimicrobial system may be used as a laundering additive or in other applications as discussed herein.

In some embodiments, the antimicrobial system may be used as, or as part of, a hard surface disinfectant that gives rapid disinfection combined with durability and longevity of the disinfecting activity. An exemplary system may include silver chloride (0.004%) on a titanium dioxide carrier or other inert carriers, combined with conventional disinfectant. In this case a quaternary ammonium compound (0.4% N, N-didecyl N,N-dimethylammonium chloride). With conventional disinfectants the efficacy is reduced or completely removed within 24 hours of application. The silver salt continues to work for three months or more. The combination of the quaternary ammonium compound, or other primary disinfectant with the silver chloride does not appear to interfere with the efficacy of either product. For example, the product may be applied to the hard surface and it will be disinfected within minute according to ASTM test methods. The silver chloride will go on working while on the surface and organisms will be continuously killed after three months or even longer. It has also been shown that water and wiping does not significantly reduce the efficacy of the silver chloride on many surfaces.

The primary disinfectant may be selected from any of a variety of conventional disinfectants. These may include oxidizing disinfectants such as sodium hypochlorite, peracetic acid and hydrogen peroxide. Non-oxidizing disinfectants such as quaternary ammonium compounds, biguanides and amphoterics may also be used, with quaternary ammonium compounds being particularly suitable.

Other conventional disinfectants include sodium hypochlorite, chlorine dioxide, hydrogen peroxide, peracetic acid, iodophors, and alcohols.

In some embodiments, the silver chloride coated inert carrier particles may be blended with a stabilizer, an emulsifier, and the primary disinfectant, (such as a quaternary ammonium salt) to provide a stable product. The product may be trigger spray applied, wiped from bulk liquid, aerosolized or combined into a wet wipe form.

While surface treatments such as wipes and sprays may be greatly improved by use of the antimicrobial system, other applications may also be improved by either the liquid or solid matrix formulations. By way of example, long acting antimicrobial systems may be particularly suitable in laundering applications. There has been a trend to move away from conventional laundry liquids and towards the use of biological systems. Some of these utilize enzymes but have been found to irritate skin. At lower temperatures enzyme treatments are generally not sufficiently effective for killing bacteria and other microorganisms. At lower temperatures there may be nearly no biocidal activity with colored wash laundry products, and in many cases, the wash temperatures may actually result in the proliferation of organisms. In the case of white washers an in-situ created peroxide is used as a bleaching agent. This does kill organisms but has little or no residual effect.

An exemplary laundry additive may consist of silver chloride (0.016%) on a titanium dioxide carrier (this may be other silver salts and other inert carriers) combined with zinc ricinoleate compounds and sequestrants such as EDTA (0.1%) (sodium or calcium with calcium preferred). Alternative agents include glucose delta lactone, sodium gluconate, potassium gluconate, sodium tripolyphosphaste and sodim hexa meta-phosphate or any suitable chelating agent. The addition of the zinc ricinoleate may deodorize chemical smells. The silver chloride kills a broad spectrum of microorganisms. The sequestrant may chelate metal ions in the water that may interfere with the deposition of the silver chloride coated inert particles. Since silver chloride does not dissociate in water the product may be made in the form of a stable liquid or a tablet.

In some embodiments, the required amount of liquid or the tablet laundry additive may bee placed in the fabric conditioner tray of the washing machine. This may help ensure that the product is employed at the end of the washing cycle and is not elutriated during the washing phase. On drying the silver chloride will begin to destroy micro-organisms and will continue to do so while the article is in use. Zinc ricinoleate may also continue to function. The particle size of the titanium dioxide or other inert carrier should be sufficiently small so that it is entrapped in the fabrics being washed.

The individual components of the antimicrobial system may blended together according to wash size, desired end use, and addition rates. The system may then be and bottled or pelletized. In some embodiments, a primary disinfectant (a water soluble or miscible product such as a quaternary ammonium compound) is added in the first rinse cycle of the wash. These are typically five-minute acting biocides. This addition removes microbiological contamination and is itself removed during the remaining wash cycles. The product above is then added at the final stage as previously stated.

### EXAMPLES

An antimicrobial system was prepared by combining a mixture having silver chloride coated onto titanium dioxide particles with a mixture having dialkyl dimethylammonium bicarbonate/carbonate. Specifically, the system was prepared with JMAC LP 10 (2% Silver Chloride, 7-9% titanium dioxide, and less than 2% ethanol in water) available from CLARIANT and CARBOQUAT 250 T (2% N-methyldidecylamine, 3% methanol, 6% propylene glycol, 37% water and the balance being N, N-didecyl-N, N-dimethylammonium carbonate and N, N-didecyl-N, N-dimethylammonium bicarbonate) available from LONZA. The combination is diluted to a silver chloride concentration of 0.004% and a quaternary ammonium concentration of 0.4%. The viscosity of the system was adjusted by addition of xanthan gum (FMC XG 80 available from FMC BIOPOLYMER).

The system was used in the preparation of wipes and a spray disinfectant. The system was found to be effective against a broad spectrum of micro-organisms including salmonella enterica, staphylococcus aureus, pseudomonas aeruginosa, methicillin resistant staphylococcus aureus, vancomycin resistant enterococcus faecalis, trichophyton mentagrophytes, mycobacterium bovis, poliovirus, rhinovirus, and influenza A virus (H3N2). In many cases, the treated surface remained resistant to micro-organisms for up to three months.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. An antimicrobial system comprising:
inert carrier particles;
a silver salt coated onto the inert carrier particles; and
a matrix into which the inert carrier particles are dispersed.

2. The antimicrobial system of claim 1, wherein the matrix is a liquid and the silver salt is silver chloride, the system further comprising:
an agent for dispersing the inert carrier particles into the matrix, the agent selected from the group consisting of surfactants, dispersants, and stabilizers.

3. The antimicrobial system of claim 2 wherein the agent for dispersing the inert particles into the matrix are selected from the group consisting of alcohols, polyols, and mixtures thereof.

4. The antimicrobial system of claim 1, wherein the inert carrier particles comprise titanium dioxide.

5. The antimicrobial system of claim 1, wherein the matrix is a solid matrix comprising inert bulking agents.

6. The antimicrobial system of claim 5, further comprising a surfactant.

7. The antimicrobial system of claim 6, wherein the the inert carrier particles comprise titanium dioxide.

8. The antimicrobial system of claim 1, further comprising a primary disinfectant.

9. The antimicrobial system of claim 8, wherein the primary disinfectant comprises a quaternary ammonium compound.

10. A disposable wipe for use in cleaning and disinfecting, the disposable wipe comprising:
a fibrous substrate;
a liquid carrier impregnated throughout the fibrous substrate;
inert carrier particles distributed over the substrate; and
silver chloride coated onto the inert carrier particles.

11. The disposable wipe of claim 10, further comprising:
an agent for dispersing the inert carrier particles into the liquid carrier, the agent selected from the group consisting of surfactants, dispersants, and stabilizers.

12. The disposable wipe of claim 11 wherein the agent for dispersing the inert particles into the matrix are selected from the group consisting of alcohols, polyols, and mixtures thereof.

13. The disposable wipe of claim 12, further comprising a primary disinfectant.

14. The disposable wipe of claim 13, wherein the primary disinfectant comprises a quaternary ammonium salt.

15. A sprayable disinfectant comprising:
a liquid carrier;
inert carrier particles dispersed in the liquid carrier; and
silver chloride coated onto the inert carrier particles.

16. The sprayable disinfectant of claim 15, further comprising:
an agent for dispersing the inert carrier particles into the liquid carrier, the agent selected from the group consisting of surfactants, dispersants, and stabilizers.

17. The sprayable disinfectant of claim 15, wherein the agent for dispersing the inert particles into the matrix are selected from the group consisting of alcohols, polyols, and mixtures thereof.

18. The sprayable disinfectant of claim 15, further comprising a primary disinfectant.

19. The sprayable disinfectant of claim 18, wherein the primary disinfectant comprises a quaternary ammonium salt.
